(19) United States
(12) Patent Application Publication
(10) Pub. No.: US 2020/0346911 A1
(43) Pub. Date: Nov. 5, 2020

(54) Method for controlling a modulating filling valve and filling device for performing such method

(71) Applicant: SIDEL PARTICIPATIONS, Octeville-sur-mer (FR)

(72) Inventors: Stefano D'ERRICO, Parma (IT); Annalisa MALFATTO, Parma (IT)

(21) Appl. No.: 16/957,098

(22) PCT Filed: Dec. 11, 2018
(86) PCT No.: PCT/EP2018/084322

§ 371 Date: Jun. 22, 2020

(30) Foreign Application Priority Data
Dec. 21, 2017 (IT) 102017000148519

(51) Int. Cl. B67C 3/00; B67C 3/28

(52) U.S. Cl. CPC B67C 3/007; B67C 3/287; B67C 3/286

(57) ABSTRACT

The invention relates to a method for controlling a modulating valve during a filling operation on a plurality of receptacles to fill them with a pourable product. The valve includes a shutter for closing or opening an outflow passage of the valve, designed to control the filling of receptacles. The method includes measuring the flowrate of the pourable product passing through the valve; measuring the position of the shutter along the axis; and controlling the position of the shutter as a function of the desired flowrate. The method also includes defining an initial table containing at least the flowrate and position values measured prior to a first filling during the same filling operation; and updating the table with flowrate and position values measured during fillings subsequent to the first filling during the same filling operation. The controlling step is carried out as a function of the table.

### FIELD OF INVENTION

The present invention relates to a method for controlling a modulating valve for filling receptacles, for example bottles or the like, with a pourable product at a pressure greater than the atmospheric pressure, for example a carbonated drink.

The present invention furthermore relates to a device for filling receptacles with a pourable product at a pressure greater than the atmospheric pressure.

### BACKGROUND OF THE INVENTION

Filling machines are known, essentially comprising a carousel rotating around a vertical axis, a tank containing the pourable product, and a plurality of filling devices peripherally carried by the carousel, connected to the tank by means of respective circuits or ducts and conveyed from the carousel itself along a circular transfer path.

Each filling device essentially comprises:

a support element adapted to receive and hold in a vertical position, below the device itself, a respective receptacle; and

a modulating filling valve configured to feed a pre-set volume of pourable product to said receptacle, while the filling device moves along the transfer path due to the rotary movement imparted by the carousel.

Typically, modulating filling valves of the known type essentially comprise:

a vertical tubular body fixed to a peripheral portion of the carousel and defining a vertical flow channel for feeding the pourable product to a respective receptacle to be filled, arranged below the tubular body itself; and

a shutter which slidingly engages the tubular body and is mobile inside the channel, in order to open or close in a variable manner, and outflow passage of the pourable product towards the respective receptacle.

In particular, the tubular body has a longitudinal axis parallel to the axis of the carousel and ends at a lower end with an axial outlet opening fluidically communicating, in use, with an end opening defined by an upper edge of the respective receptacle to be filled.

The channel defined by the tubular body comprises a stretch having a constant section, usually cylindrical, and a stretch with variable section, positioned above the outlet opening and narrowing in the direction of the latter, up to a minimum-diameter section.

In modulating filling valves of a known type, the shutter is movable within the channel of the tubular body in a plurality of positions ranging between a position of maximum closure, wherein the shutter closes in a sealed manner the minimum-diameter section, in order to interrupt the flow of the pourable product towards the outlet opening, and a position of maximum aperture, wherein the shutter delimits together with the minimum-diameter section, an annular outflow passage of maximum aperture fluidically communicating with the outlet opening, so as to allow the flow of the pourable product towards the end opening of the respective receptacle.

Therefore, the shutter is movable between the position of maximum closure and the position of maximum aperture in a plurality of intermediate opening positions, defining with the minimum-diameter section respective intermediate annular outflow passages with increasing dimensions.

In order to control the movement of the shutter between the aforementioned positions, the modulating filling valves comprise an actuator, typically of the electromagnetic type.

In particular, the actuator comprises a coil arranged inside the tubular body and configured to be magnetically coupled to one or more permanent magnets appropriately included in the shutter.

Typically, the aforementioned filling devices further comprise a flowrate sensor, for example a flowmeter, configured for measuring the flowrate of the pourable product passing through the channel of the tubular body and for generating a correlated flowrate signal, and a position sensor configured for measuring the position of the shutter inside the channel and for generating a correlated position signal. The filling devices of the known type furthermore comprise, a control unit configured for receiving the aforementioned flowrate and position signals and for controlling the movement of the shutter as a function of said flowrate and position signals.

In detail, the coil of the actuator receives, in use, command signal from the control unit and produces, according to a known mode of operation typical of the coils, a corresponding magnetic field adapted to move the shutter by means of magnetic interaction with the permanent magnets included in the shutter itself.

In this manner, it is possible to control the opening of the modulating valve in correlation with the flowrate passing through the valve itself and the position of the shutter inside the channel measured by the respective sensors.

However, the measurement of the above-mentioned flowrate obtained by means of a flowmeter, is particularly inefficient for controlling the opening of the modulating valves currently in use in the field, since the flowrate signals are output by the known flowmeters with a relatively considerable delay in comparison to the operating speed of such modulating valves. In fact, the known flowmeters operate at a speed of approximately 12.5 milliseconds, whereas the known modulating valves complete filling cycles in approximately 10 milliseconds. Therefore, an individual modulating filling valve receives the command signal output by the control unit with a considerable delay, due to the slowness of the flowrate measurements and of the sending of correlated signals from the flowmeter to the control unit.

### BRIEF SUMMARY OF THE INVENTION

The aim of the present invention is to provide a method for controlling a modulating valve that allows to overcome the aforementioned drawbacks, related to the known control methods, in a simple and economic manner.

According to the present invention, this aim is achieved by a method of controlling a modulating filling valve.

The present invention furthermore relates to a filling device.

### BRIEF DESCRIPTION OF THE DRAWINGS

For a better understanding of the present invention, two non-limiting embodiments will now be described, purely by way of example and with the help of the attached drawings, wherein:

FIG. 1 schematically shows, with parts removed for clarity, a filling device operating according to the method object of the present invention;

FIG. 2 is a diagram showing three different characteristic curves of a modulating valve of the filling device of FIG. 1;

FIG. 3 schematically shows, with parts removed for clarity, a different embodiment of the filling device operating according to the method object of the present invention; and

FIG. 4 is a three-dimensional diagram showing three different characteristic curves of a modulating valve of the filling device of FIG. 3.

### DETAILED DESCRIPTION

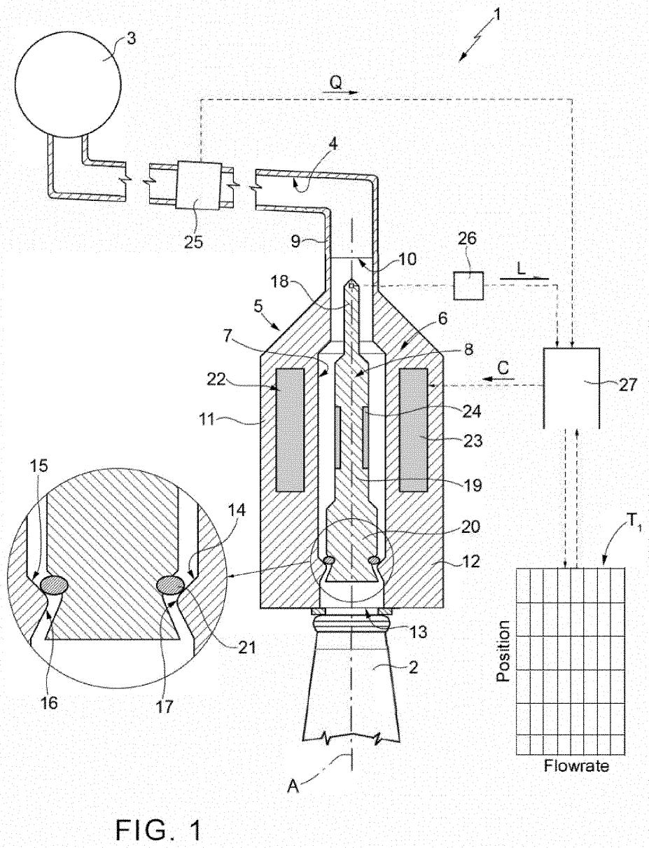

With reference to FIG. 1, number 1 indicates as a whole, a filling device configured for filling, to a predetermined level, a respective receptacle 2 with a pourable product at a pressure value greater than the atmospheric pressure, for example a carbonated beverage.

In particular, the filling device 1 is fluidically connected, by means of a duct 4, to a pressurised tank 3 (only partially illustrated) containing the pourable product.

As can be seen in FIG. 1, the filling device comprises a filling valve 5 of the modulating type, which can be selectively activated to control the outflow of the pourable product towards the receptacle 2 to be filled. In this configuration, the receptacle 2 is positioned below and in contact with the valve 5, in order to receive from the latter, the pourable product by the action of gravity and in a fluid-tight condition.

Therefore, the filling device 1 is configured for carrying out a “contact filling operation”, wherein the receptacle 2 is supported in fluid tight contact against the corresponding valve 5.

The valve 5 essentially comprises:

a tubular body 6, having a vertical axis A and defining a central flow channel 7 configured for feeding the pourable product into the receptacle 2; and

a shutter 8 slidingly engaging the tubular body 6 and movable inside the channel 7 in order to enable or prevent the outflow of the pourable product towards the respective receptacle 2 to be filled.

In particular, the tubular body 6 has an upper end portion 9 provided with an inlet opening 10 axially configured to receive the pourable product from the tank 3 through the duct 4, an intermediate portion 11, and a lower end portion 12 ending with an outlet opening 13 axially configured for feeding the pourable product into the respective receptacle 2.

With reference to the embodiment shown in FIG. 1, the channel 7 comprises, at the lower end portion 12 of the tubular body 6, a portion with variable section 14 having two frustum conical stretches 15, 16. In particular, the stretch 15 is positioned upstream of the stretch 16 in respect to the feeding direction of the pourable product inside the channel 7, namely arranged superiorly with respect to the stretch 16 itself, and has a section tapering towards the latter; the stretch 16 instead has a diameter increasing from the stretch 15 up to the outlet opening 13. Therefore, the two stretches 15, 16 define between one another, a narrowed section 17, namely a minimum-diameter section.

As can be seen in FIG. 1, the shutter 8 is axially fitted within the channel 7 of the tubular body 6.

In particular, the shutter 13 comprises an upper end portion 18, an intermediate portion 19, having a diameter greater than the diameter of the upper portion 18 and axially extending therefrom in the direction of the outlet opening 13, and a shaped terminal portion 20, configured for cooperating with the portion of the tubular body 6 defining the portion with variable section 14 of the channel 7.

In particular, the terminal portion 20 is provided with a sealing ring 21, for example an O-ring made in elastomeric material, configured for selectively cooperating in a fluid-tight manner with the narrowed section 17 of the channel 7, in order to prevent or enable the outflow of the pourable product towards the outlet opening 13 and, therefore, into the receptacle 2 to be filled.

For this purpose, the shutter 8 is movable within the channel 7 of the tubular body 6 in a plurality of positions ranging between:

a closed position, wherein the shutter 8 seals in a fluid tight manner, by means of the sealing ring 21, the narrowed section 17 of the channel 7, in order to prevent the outflow of the pourable product towards the outlet opening 13; and

a position of maximum aperture, wherein the shutter 8 delimits together with the narrowed section 17 of the channel 7 an annular passage of maximum outflow fluidically communicating with the outlet opening 13, in order to allow the outflow of the pourable product towards the receptacle

Practically, the shutter 8 is movable, between the aforementioned positions of closure and maximum aperture, in a plurality of intermediate opening positions which are virtually unlimited and defining respective intermediate outflow annular passages with gradually increasing openings, as the shutter 8 proceeds from the closure position to the maximum aperture position.

In other words, during its movement along the axis A starting from the position of closure, the shutter 8 delimits with the narrowed section 17 an outflow passage with variable dimension adapted to control the filling speed of the receptacle 2.

In order to control the movement of the shutter 8 between the aforementioned positions, the valve 5 comprises an actuator 22, for example an electromagnetic type actuator.

In particular, the actuator 22 comprises a coil 23 arranged around channel 7 at the intermediate portion 11 of the tubular body 6 and configured to be magnetically coupled to one or more permanent magnets 24 appropriately included in the intermediate portion 19 of the shutter 8.

As can be seen in FIG. 1, the filling device 1 further comprises:

flowrate sensor, for example a flowmeter 25 configured for measuring the flowrate of the pourable product passing through the valve 5 and for generating a flowrate signal Q correlated with the measured flowrate;

a position sensor 26, for example a Hall sensor, configured for measuring the position of the shutter 8 along the axis A within the channel 7 and for generating a position signal L correlated with the measured position; and

a control unit 27 configured for receiving the flowrate Q and position L signals and for controlling the activation of the actuator 22 as a function of said signals Q and L.

In one embodiment, the flowmeter 25 is arranged in correspondence of the duct 4, in order to measure, in use, the flow of the pourable product passing through the duct 4 itself and direct it towards the valve 5, and the position sensor 26 is arranged at the upper portion 18 of the shutter 8.

According to the diagram illustrated in FIG. 1, the coil 23 receives, in use, a command signal C from the control unit 27, correlated with the flowrate Q and position signals, and consequently produces, according to a known mode of operation of the coils, an electromagnetic field adapted to magnetically interact with the permanent magnets 24 included in the shutter 8, so as to move the shutter 8 itself inside the channel 7. In this manner, it is possible to control the opening of the valve 5 in correlation with the position of the shutter 8 inside the channel 7 and the flowrate passing through the valve 5 itself measured by the respective sensors 26 and 25.

According to an important aspect of the present invention during a filling operation carried out, without any interruptions of production, on a plurality of receptacles 2, the control unit 27 commands the position of shutter 8 along the axis A as a function of a table T1, which at the start of the operation (initial table T1) contains flowrate and position values measured respectively by the flowmeter 25 and by the position sensor 26 prior to a first filling of the filling operation itself, and successively is updated (table T1 updated) with flowrate and position values respectively measured by the flowmeter 25 and the position sensor 26 during respective fillings of the filling operation itself after the first filling.

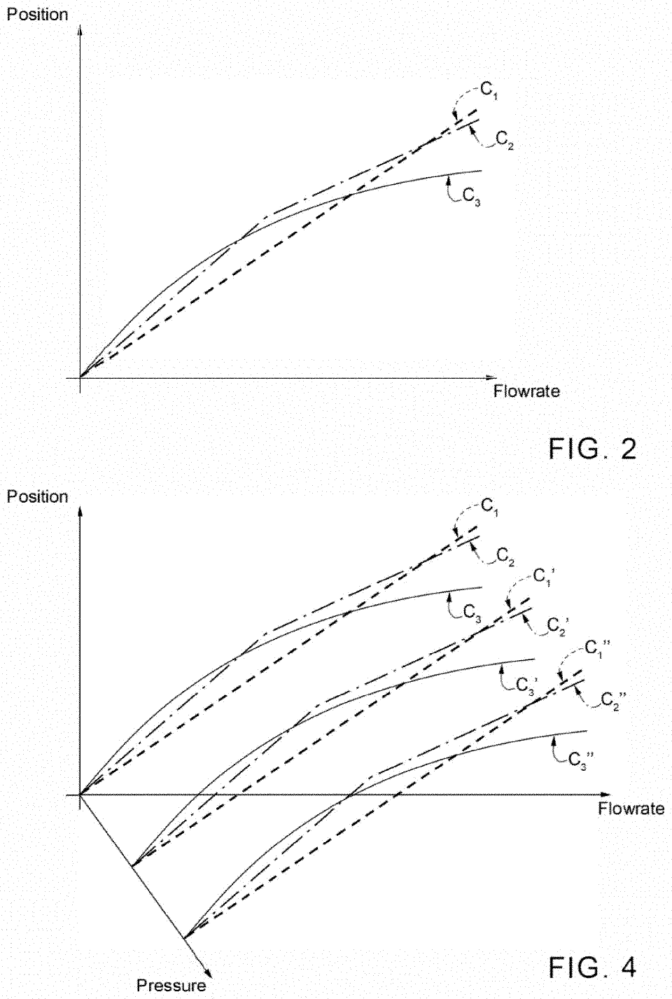

In particular, the table T1 can be created by means of one or more initial flowrate and position measurements prior to the first filling, in order to obtain a characteristic curve C1 of the valve 5 or a characteristic curve C2 of the valve 5 (FIG. 2), representing on a 2D diagram position-flowrate an initial filling law of the valve 5 itself, at different accuracy levels. In greater detail and with reference to the diagram shown in FIG. 2, the characteristic curve C2 (obtained by means of two measurements) represents an initial filling law of the valve with a precision level greater than that of the characteristic curve C1 (obtained by means of a single measurement).

It should be noted that the initial table T1 may also be defined by the updated table T1 obtained at the end of a previous filling operation, for example before a programmed or undesired machine downtime.

The initial table T1 may be furthermore used at any moment during the filling operation, whenever a recalibration of the filling device 1 is required, for example following a certain number of non-standard fillings.

Due to the continuous updating of the table T1 it is possible to obtain a characteristic curve C3 representing on the position-flowrate diagram of FIG. 2 an effective filling rule of the valve 5.

In other words, by continually updating the table T1 with flowrate and position values measured respectively by the sensors 25 and 26 during filling operations after the first one, the filling law is gradually updated, which automatically adapts to actual operating conditions of the valve 5 during the relative filling operation. In fact, the component of the valve 5 can be subject, during the various filling cycles, to dimensional variations caused by overheating, friction, geometric tolerance.

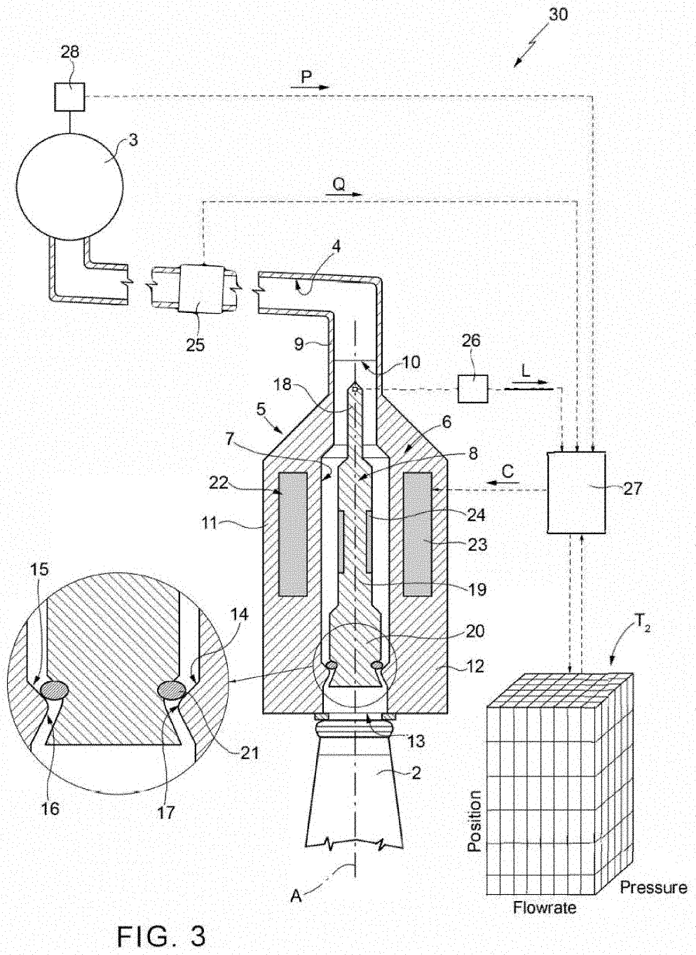

In FIG. 3, the reference numeral 30 indicates as a whole, a different embodiment of the filling device according to the present invention.

As the filling device 30 is similar in terms of structure and function to the filling device 1, the following description is limited to the substantial differences between the two; the parts of the filling device 30 equal or corresponding to the parts already described in relation to the filling device 1 will be indicated by using, whenever possible, the same reference numbers.

In particular, the filling device 30 comprises a pressure sensor 28 configured for measuring the pressure of the pourable product inside the tank 3 and for generating a pressure signal P correlated with the pressure measured.

In such configuration, during the filling operation carried out, without any interruptions of production, on a plurality of receptacles 2, the control unit 27 commands the positioning of the shutter 8 along the axis A as a function of the three-dimensional table T2, which at the start of the operation (initial table T2) contains flowrate, position and pressure values measured respectively by the flowmeter 25, the position sensor 26 and pressure sensor 28 prior to a first filling of the filling operation itself and subsequently is updated (table T2 updated) with flowrate, position and pressure values respectively measured by the flowmeter 25, the position sensor 26 and by the pressure sensor 28 during respective subsequent fillings of the filling operation itself, i.e. after the first filling.

In other words, the control unit 27 is further configured for associating the flowrate and position values to respective pressure values measured by the pressure sensor 28.

In particular, as is the case for table T1, the table T2 can be created by means one or more initial flowrate and position measurements prior to the first filling and for a given pressure value p1, in order to obtain respective characteristic curves C1 or C2 at different accuracy levels. Successively, such measurements are carried out for other pressure values p2, p3, etc., in order to obtain respective characteristic curves C1′ and C2′, C1″ and C2″, etc., valid for the aforementioned pressure values p2, p3, etc. (FIG. 4).

It should be noted that the initial table T2 may also be defined by the updated table T2 obtained at the end of a prior filling operation, for example before a programmed undesired machine downtime.

The initial table T2 may be furthermore used, at any moment of the filling operation whenever a recalibration of the filling device 30 is required.

Due to the continual updating of the table T2 it is possible to obtain a characteristic curve C3, C3′, C3″, etc., representing on a three-dimensional diagram position-flowrate-pressure of FIG. 4 respective effective filling laws of the valve 5 of the filling device 30.

In other words, by continually updating the three-dimensional table T2 with flowrate, position and pressure values measured by respective sensors 25, 26 and 28 during filling operations subsequent to the first, the effective filling law is gradually updated, which automatically adapts to actual operating conditions of the valve 5 during the relative filling operation 1.

Definitively, due to the continuous updating of the tables T1, T2, the actuator 22 of the shutter 8 of the valve 5 receives the command signal C output by the control unit 27 as a function of such tables T1, T2 at a speed of many orders of magnitude greater in respect to the case in which the command signal C is only output as a function of the flowrate values measured by the flowmeter 25. In fact, in this latter case, the control unit 27 should wait to receive the flowrate signal Q from the flowmeter 25 before being able to control the movement of the shutter 8

In addition, the possibility of obtaining different filling laws as a function of different pressure values allows to increase the flexibility of the filling device 30 in the case in which filling operations must be carried out at different pressure levels.

It is thus clear that modifications and variations can be made to the method and to the filling device 1 described and illustrated herein, without departing from the scope of protection defined by the claims.

1. A method for controlling a modulating valve (5) during a filling operation carried out, without interruptions of production, on a plurality of receptacles (2) for filling them with a pourable product under pressure, said valve (5) comprising a shutter (8) movable along an axis (A) for closing or opening in a variable manner an outflow passage of the valve (5) itself designed to control the filling of said receptacles (2) with said pourable product;
said method comprising the steps of
measuring the flowrate of said pourable product passing through said valve (5) by means of a flowmeter (25);
measuring the position of said shutter (8) along said axis (A) by means of a position sensor (26);
controlling said position of said shutter (8) as a function of the desired flowrate: method further comprising:
defining an initial table (T1; T2) containing at least the flowrate and position values prior to a first filling of said receptacles (2) during said filling operation;
updating said table (T1; T2) with flowrate and position values during fillings subsequent to said first filling during said filling operation; and
measuring the pressure of said pourable product by means of a pressure sensor (28), wherein:
the controlling step is carried out as a function of said table (T1; T2),
the defining step comprises associating said flowrate and position values to respective pressure values in the measuring step, and
the updating step is carried out by including in said table (T2) said pressure values in the measuring step and associating step, respectively with said flowrate and position values.

2. The method according to claim 1, wherein said controlling step is carried out as a function of the initial table (T1; T2) defined in the defining step, while said first filling is being carried out, and according to the table (T1; T2) updated in the updating step, while said fillings subsequent to said first filling are being carried out.

3. The method according to claim 1, wherein the defining step comprises:
measuring the flowrate of said pourable product passing through said valve (5) as a function of at least a position of said shutter (8) prior to said first filling; and
storing in said initial table (T1; T2) the, flowrate value measured in the measuring step and said at least one position of said shutter (8).

4. The method according to claim 3, wherein said measuring and storing steps are repeated for more positions of said shutter (8).

5. (canceled)

6. A filling device (1; 30) comprising a modulating valve (5) having a shutter (8) movable along an axis (A) for closing or opening in a variable manner an outflow passage of the valve (5) itself designed to control the filling of receptacles (2) with a pourable product under pressure;
said filling device (1; 30) further comprising:
a flowrate sensor (25) configured for measuring the flowrate of said pourable product passing through said valve (5) and for generating a flowrate signal (Q) correlated with the measured flowrate;
a position sensor (26) configured for measuring the position of said shutter (8) along said axis (A) and for generating a position signal (L) correlated with the measured position; and
a control unit (27) configured for receiving said flowrate (Q) and position (L) signals and controlling the positioning of said shutter (8) along said axis (A) as a function of said flowrate (Q) and position (L) signals;
a pressure sensor (28) configured for measuring the pressure of said pourable product inside a tank (3) and for generating a pressure signal (P) related to the pressure measured,
wherein the positioning of said shutter (8) along said axis is commanded by said control unit (27) as a function of a table (T1; T2), which, at the start of a filling operation carried out, without interruptions of production, on a plurality of receptacles (2), contains at least the flowrate and position values measured respectively by said flowrate sensor (25) and by said position sensor (26) prior to a first filling of said receptacles (2) during said filling operation, and subsequently is updated with the flowrate and position values measured respectively by said flowrate sensor (25) and by said position sensor (26) during respective fillings subsequent to said first filling, and
wherein said control unit (27) is further configured for associating said flowrate and position values to respective pressure values measured by the pressure sensor (28).

7. The device according to claim 6, wherein said valve (5) receives said pourable product from the tank (3) pressurised through a duct (4); said valve (5) comprising a hollow body (6) coaxial to said axis (A) and defining a flow channel (7) for said pourable product housing said shutter (8);
said flowrate sensor (25) being arranged at said duct (4) and measuring the flowrate passing through said duct (4);
said position sensor (26) being arranged in correspondence with said shutter (8).

8. (canceled)

9. The device according to claim 6, further comprising an electromagnetic actuator (22) configured for receiving a command signal (C) from said control unit (27) correlated with said table (T1; T2) and for controlling the movement of said shutter (8) within said channel (7).

10. The method according to claim 2, wherein the defining step comprises:
measuring the flowrate of said pourable product passing through said valve (5) as a function of at least a position of said shutter (8) prior to said first filling; and
storing in said initial table (T1; T2) the flowrate value measured in the measuring step and said at least one position of said shutter (8).

11. The device according to claim 7, further comprising an electromagnetic actuator (22) configured for receiving a command signal (C) from said control unit (27) correlated with said table (T1; T2) and for controlling the movement of said shutter (8) within said channel (7).

12. The device according to claim 8, further comprising an electromagnetic actuator (22) configured for receiving a command signal (C) from said control unit (27) correlated with said table (T1, T2) and for controlling the movement of said shutter (8) within said channel (7).
